(19) United States
(12) Patent Application Publication
(10) Pub. No.: US 2006/0265617 A1
(43) Pub. Date: Nov. 23, 2006

(54) Power management in a system having multiple power modes

(76) Inventor: Anthony L. Priborsky, Lyons, CO (US)

Correspondence Address: H. Sanders Gwin, Jr.;Shumaker & Sieffert, P.A., Suite 105, 8425 Seasons Parkway, St. Paul, MN, 55125, US

(21) Appl. No.: 11/132,137

(22) Filed: May 18, 2005

(51) Int. Cl. G06F 1/26

(52) U.S. Cl. 713/320

(57) ABSTRACT

A power management method may include initiating, in a system having at least two power modes, a transition between a first power mode and a second power mode. The method may include determining when the transition between the first power mode and the second power mode is complete. Optionally, the method may include determining when a transition from the second power mode to the first power mode occurs. The method may include measuring a time period associated with the transition between power modes. The above actions may be repeated to obtain a plurality of measurements, and an average value of a two or more of the measurements may be calculated. The method may further include determining a time at which the system is to transition to the second power mode. The time may be a function of the measured time period or of the average value.

### FIELD OF THE DISCLOSURE

This disclosure relates to power management in a system having multiple power modes.

### BACKGROUND

To conserve power, a system may operate in two or more power modes. For example, a system that performs a number of functions may transition between different power modes, depending on which functions the system is performing. Whether the system transitions between power modes may also depend on a time required for the transition. For example, the system may transition from an active power mode to a reduced power mode if the system determines that the active power mode is not necessary to perform its current functions, and if the system could transition back to the active power mode quickly enough if the active power mode were required again.

### SUMMARY

A system may use a power management method to transition between two or more power modes. Transition times between power modes in the system may be roughly characterized by a design document or specification. For example, the system may be designed according to a specification that roughly characterizes a maximum transition time between power modes. The power management method may transition between power modes based on the rough characterization of maximum transition time. For example, if the system predicts that a current idle period will exceed the maximum time to transition from a reduced power mode to active power mode, the system may transition to the reduced power mode. Actual transition times between the power modes may be shorter than times indicated by the rough characterization.

An exemplary power management method may transition between power modes based on actual transition times between the power modes. The exemplary power management method may include initiating, in a system having at least two power modes, a transition between a first power mode and a second power mode. The method may include determining when the transition between the first power mode and the second power mode is complete. Optionally, the method may include determining when a transition from the second power mode to the first power mode occurs. The method may include measuring a time period associated with the transition between power modes. The above actions may be repeated to obtain a plurality of measurements, and an average value of a two or more of the measurements may be calculated. The method may further include determining a first time at which the system is to transition to the second power mode. The first time may be a function of the measured time period or of the average value and further a function of a length of time at least part of the system is in an idle state. If the second power mode is selected from a plurality of reduced power modes, the power management method may perform the above actions for each reduced power mode.

Various embodiments may have one or more advantages. For example, a system that transitions between power modes based on an actual transition time may conserve more power than a system that transitions between power modes based on a rough characterization. The system may transition to a reduced power mode more frequently, and it may remain in the reduced power mode longer.

The details of one or more embodiments are set forth in the accompanying drawings and the description below. Other features, objects, and advantages will be apparent from the description and drawings, and from the claims.

### DESCRIPTION OF DRAWINGS

FIG. 1 is a block diagram of an exemplary computer system in which a power management method may be implemented.

FIG. 2 is a block diagram showing an exemplary serial advanced technology attachment (SATA) data processing system.

FIG. 3 is a waveform diagram of exemplary differential data that may be transmitted by a SATA transmitter or received by a SATA receiver.

FIG. 4 is another waveform diagram of exemplary differential data that may be transmitted by the SATA transmitter or received by the SATA receiver.

FIG. 5 is an exemplary timing diagram showing relative timing between various signals during a transition between an active power mode and a reduced power mode.

FIG. 6A is a block diagram of an exemplary timer circuit for determining transition time to a reduced power mode, from an active power mode (“sleep time”).

FIG. 6B is a block diagram of an exemplary timer circuit for determining transition time to an active power mode, from a reduced power mode (“wakeup time”).

FIG. 7 is a flow diagram of an exemplary method for determining transition time between a first power mode and a second power mode.

Like reference symbols in the various drawings indicate like elements.

### DETAILED DESCRIPTION OF EXEMPLARY EMBODIMENTS

A system that transitions between power modes based on an actual transition time may conserve more power than a system that transitions between power modes based on a rough characterization. The rough characterization may be a maximum transition time between power modes described by a specification to which the system adheres.

A data processing system that includes a serial advanced technology attachment (SATA) interface may include multiple power modes. Two exemplary specifications may characterize aspects of a SATA interface: Serial ATA: High Speed Serialized AT Attachment, Revision 1.0a specification and the Serial ATA II: Electrical Specification, Revision 1.0 (“the SATA specifications”). These SATA specifications may be publicly available at http://www.sata io.org. The SATA specifications may characterize an active power mode and two exemplary reduced power modes: “partial” and “slumber.” The SATA specifications may indicate that a SATA interface should transition from a partial reduced power mode to an active power mode within 10 microseconds (μs) of when the transition is initiated, and from a slumber reduced power mode to an active power mode within 10 milliseconds (ms) of when the transition is initiated.

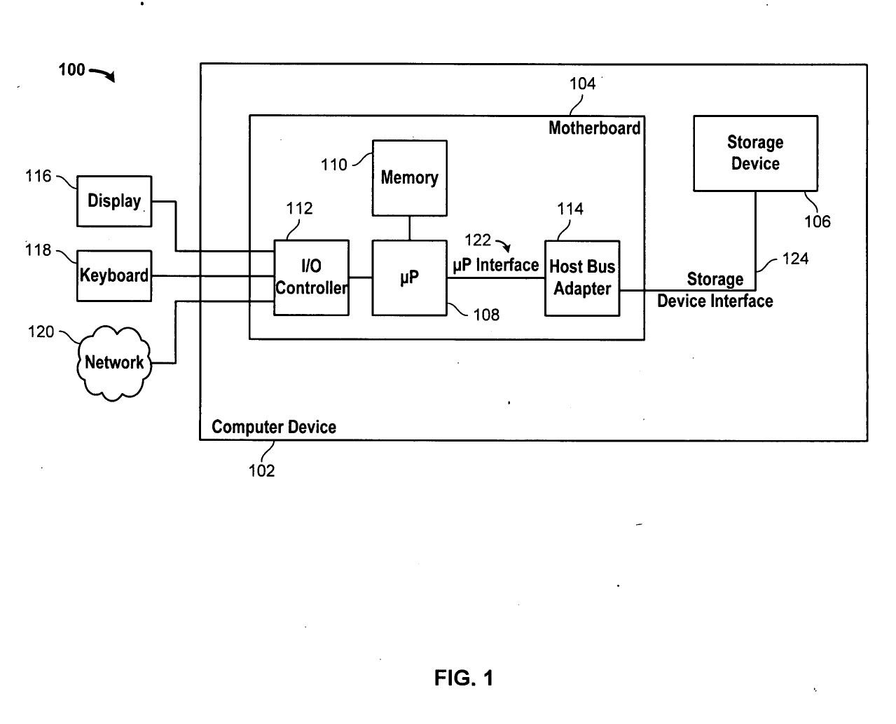

FIG. 1 is a block diagram of an exemplary embodiment of a computer system 100 in which a power management method may be implemented. The computer system 100 includes a computer device 102 comprising a motherboard 104 and a data storage device 106. The motherboard 104 includes a microprocessor (μP) 108, memory 110, an I/O controller 112, and a host bus adapter 114. The I/O controller 112 allows the computer device 102 to interface external input/output devices, such as a display 116, a keyboard 118, or a network 120. The microprocessor 108 is operatively coupled to the host bus adapter 114 through a microprocessor interface 122, such as, for example, an ATA (Advanced Technology Attachment) bus. Additional interfaces (not shown) may be interposed between the host bus adapter 114 and the microprocessor 108. For example, a memory controller (not shown) may connect directly to the microprocessor and provide a bridge function to the host bus adapter 114. The host bus adapter 114 is operatively coupled to the data storage device 106 through a storage device interface 124. The storage device interface could be, for example, a SATA interface.

Other configurations are possible. For example, the host bus adapter 114 may couple the microprocessor 108 to more than one storage device. Moreover, the host bus adapter 114 may be a discrete component, or it may be included as functionality of the microprocessor 108 itself.

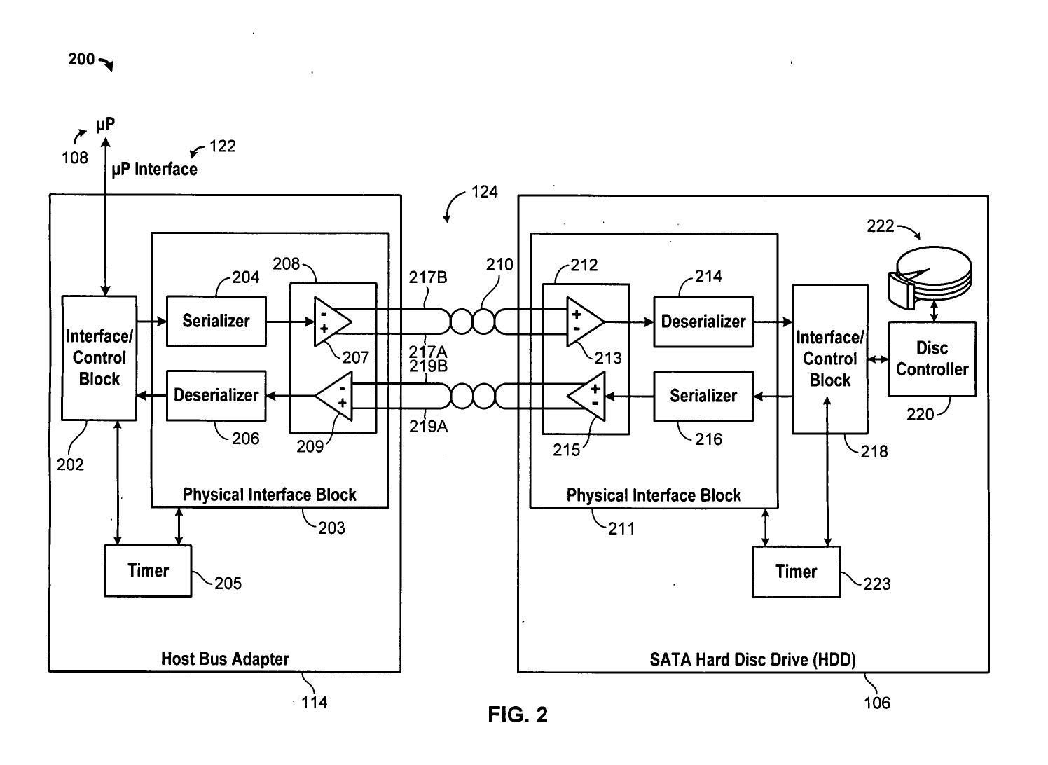

FIG. 2 is a block diagram showing an exemplary SATA data processing system 200 (SATA system 200). The SATA system 200 includes exemplary embodiments of the host bus adapter 114, the data storage device 106 and the storage device interface 124.

As shown in FIG. 2, the exemplary data storage device 106 is a hard disc drive (HDD) having a SATA interface 124. The exemplary host bus adapter 114 includes an interface and control block 202, a physical interface block 203, and a timer 205. The interface and control block 202 may receive data and commands from the microprocessor 108 over the microprocessor interface 122. The physical interface block 203 comprises a serializer 204, a deserializer 206, and an analog block 208. The analog block 208 further comprises an analog transmitter 207 and analog receiver 209. The analog transmitter 207 may comprise a digital-to-analog interface, and the analog receiver 209 may comprise an analog-to-digital interface. Data received from the microprocessor by the interface and control block 202 is serialized by the serializer 204 and transmitted over a twisted pair of wires 210, by the analog block 208, to the HDD 106.

The host bus adapter 114 could comprise a series of discrete components, or it could be a single device. For example, a system-on-a-chip (SoC) design may include the aforementioned discrete blocks in a single device. The host bus adapter 114 could also be incorporated into the microprocessor 108 itself. Further, although the exemplary embodiment comprises a twisted pair of wires 210 coupling the host bus adapter 114 and the HDD 106, the host bus adapter 114 and the HDD 106 could be coupled in other ways. For example, the twisted pair of wires 210 could be replaced with traces on a printed circuit board and connectors in a backplane environment. As shown, each pair of wires comprises a positive line 217A and 219A and a negative line 217B and 219B.

Like the host bus adapter 114, the HDD 106 also includes a physical interface block 211 comprising an analog block 212, a deserializer 214, and a serializer 216. The analog block 212 comprises an analog receiver 213 and an analog transmitter 215. In addition, the HDD 106 includes an interface and control block 218, a disc controller 220, physical storage media 222, and a timer 223. The analog block 212 receives data from the host bus adapter 114. The deserializer 214 deserializes the data. After being deserialized, the data is processed by the interface and control block 218 and the disc controller 220.

The data may comprise, for example, a read or write command. In the case of a read command, the disc controller retrieves data from a particular region of the physical media 222. The retrieved data is then serialized (216) and transmitted by the analog block 212 to the host bus adapter 114. The host bus adapter 114 receives the retrieved read data from the SATA interface 124 through its analog block 208. It deserializes (206) the data and provides it to the interface and control block 202, from which the microprocessor 108 can retrieve it.

The various components described may be discrete components, or they may be included within a single device. For example, an application specific integrated circuit (ASIC) may include the components 212, 214, 216, 218 and 220. Another ASIC may include the components 202, 204, 206 and 208.

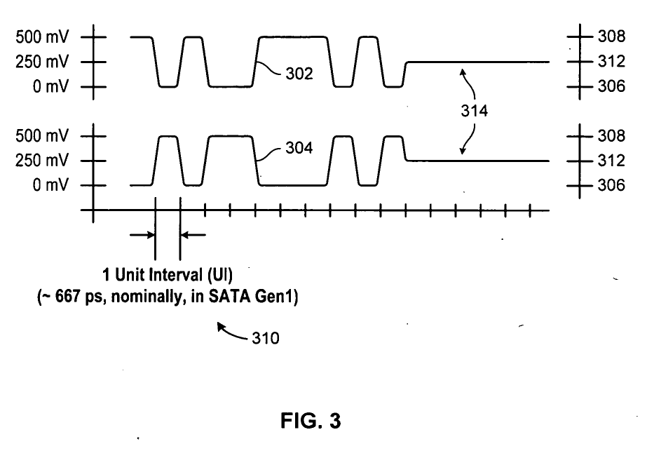

FIG. 3 shows a waveform diagram of exemplary differential data that may be transmitted by the differential transmitter 207 or 215 or received by the differential receiver 209 or 213. In FIG. 3, a vertical axis represents voltage and a horizontal axis represents time. Waveform 302 represents a time-varying voltage that may appear on the positive transmit line 217A or on the positive receive line 219A (relative to the host bus adapter 114). Waveform 304 represents a corresponding time-varying voltage that would simultaneously appear on the negative transmit line 217B or on the negative receive line 219B. The voltage of each waveform 302 and 304 varies from a low voltage 306 to a high voltage 308. Waveform 302 is a mirror image of waveform 304. That is, when the voltage represented by waveform 302 is equal to the high voltage 308, the voltage represented by waveform 304 is equal to the low voltage 306. When the physical interface blocks are in a reduced power mode, the lines 217A, 217B, 219A and 219B may be maintained at a common mode level, as pictorially represented by the level 312 in the region marked 314. Taken together, the differential waveforms 302 and 304 can represent digital values. One bit of digital data may be transmitted or received in a unit interval (UI) 310 period of time. In a first generation (Gen1) SATAinterface, one UI is nominally equal to 667 picoseconds (ps); in a second generation (Gen2) SATA interface, one UI is nominally equal to 333 ps.

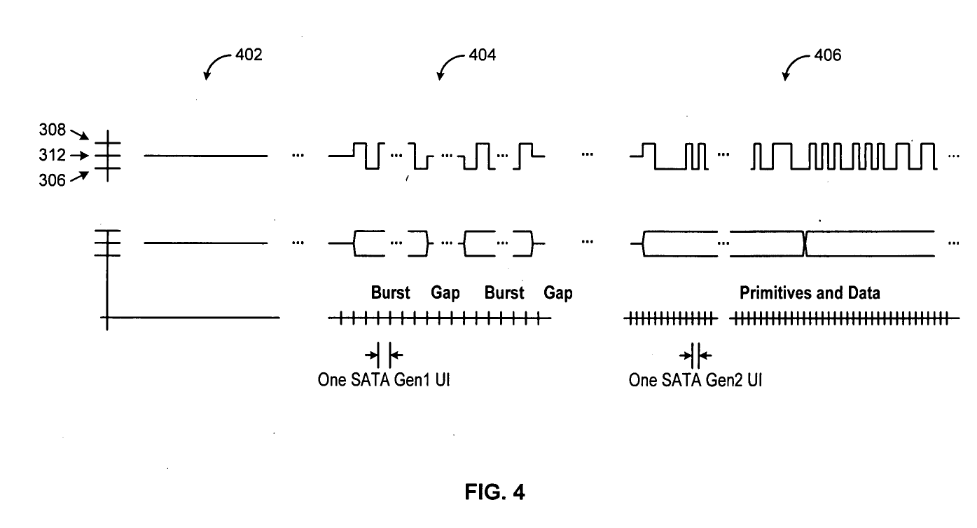

FIG. 4 shows exemplary waveforms that depict the voltage on the transmit lines 217A and 217B and the receive lines 219A and 219B (relative to the host bus adapter 114) that couple the SATA devices 106 and 114. As shown, the exemplary waveform is broken into a series of regions 402, 404 and 406, depicting different states of the exemplary SATA interface.

In region 402, the SATA interface is in a quiescent state, and voltages on the transmit lines 217A and 217B and on the receive lines 219A and 219B are at a common mode level 312. In this state, no high-speed communication link is established between the SATA devices 106 and 114.

In region 404, the SATA devices 106 and 114 may be establishing a high-speed communication link. To establish a high-speed communication link, either device may transmit a series of bit transitions (“bursts”) interspersed with a series of “gaps” (out-of-band signaling). Each burst may comprise a predetermined sequence of bit transitions. The predetermined sequence may be characterized by the SATA specifications. Bit transitions may occur at a Gen1 SATA bit-rate. Gaps may comprise a period of time when the transmit lines 217A and 217B and receive lines 219A and 219B are at a common mode level 312. The duration of each gap may also be characterized by the SATA specifications. Information may be exchanged between the devices 106 and 114 by a pattern of gaps. For example, different patterns of gaps may comprise different out-of-band signaling commands. By exchanging patterns of bursts and gaps, SATA devices may be able to establish a synchronized, high-speed communication link.

The region 406 depicts the SATA interface when a high-speed communication link is established, and where the SATA devices 106 and 114 are synchronized. In this region 406, SATA devices 106 and 114 may use “primitives,” or predefined blocks of bits, to exchange data. The SATA specifications may enumerate different primitives, they may define a function for each primitive, and they may define a series of bits that comprise each primitive. Several primitives are pertinent to this disclosure.

When a high-speed communication link is established, a clock signal may be extracted from each received bitstream, so that each differential receiver can demarcate bit boundaries. Additional bit boundaries may be characterized by the SATA specifications—for example bytes, words, “Dwords” (32 bits of data) and frames. A “SYNC” primitive may be exchanged by SATA devices, when a high-speed communication link is established. The exchange of SYNC primitives may enable the SATA devices to remain synchronized relative to the various data boundaries.

A “PMREQ_P” primitive may be transmitted from a first SATA device to a second SATA device to request a partial reduced power mode. For example, the HDD 106 could request that a portion of the SATA system 200 enter a partial reduced power mode by sending a PMREQ_P to the host bus adapter 114. Upon receipt of the PMREQ_P primitive, the host bus adapter 114 may respond with a “PMACK” primitive if it can enter a partial reduced power mode. If the host bus adapter 114 cannot enter a partial reduced power mode, it may respond with a “PMNAK” power management denial primitive. When the HDD 106 receives a PMACK primitive indicating that the host bus adapter 114 has acknowledged the partial reduced power mode, portions of the HDD 106 may also enter a partial reduced power mode.

A “TMREQ_S” primitive may be transmitted from a first SATA device to a second SATA device to request a slumber reduced power mode. As another example, the host bus adapter 114 could request that a portion of the SATA system 200 enter a slumber reduced power mode by sending a PMREQ_S to the HDD 106. Upon receipt of the PMREQ_S primitive, the HDD 106 may respond with a “PMACK” primitive. If the HDD 106 cannot enter a slumber reduced power mode, it may respond with a “PMNAK” power management denial primitive. When the host bus adapter 114 receives a PMACK primitive, indicating that the HDD 106 has acknowledged the slumber reduced power mode, portions of the host bus adapter 114 may also enter the slumber reduced power mode.

In either slumber or partial reduced power mode, portions of the SATA system 200 may be in a quiescent state, and the voltage on the SATA interface lines 124 may be at a common mode level 312. When SATA devices are in a reduced power mode, one or more functional blocks may be turned off to conserve power. For example, when the HDD 106 is in a reduced power mode, portions of the physical interface block 211 and portions of the interface and control block 218 that are associated with the SATA interface 124 may be in a reduced power mode. Other portions may remain in an active mode. For example, the physical media 222, the disc controller 220 and portions of interface and control block 218 that are associated with the disc controller 220 may remain in an active state. In this manner, an idle SATA interface 124 may be in a reduced power mode while the physical media 222, the disc controller 220 and the interface and control block 218 perform an operation with an inherent delay or access time such as, for example, a read operation. More functional blocks may be turned off in the slumber reduced power mode than in the partial reduced power mode and, consequently, more power may be conserved when a SATA device is in the slumber reduced power mode than when it is in the partial reduced power mode.

A finite period of time may be required to transition a SATA device from a reduced power mode to an active power mode. During a transition from a reduced power mode to an active power mode, functional blocks that may have been turned off may be turned back on, and synchronization may be reestablished. More time may be required to transition the SATA system 200 from the slumber reduced power mode to the active power mode than to transition the SATA interface from a partial reduced power mode to the active power mode. To enter an active power mode and reestablish synchronization, the SATA devices 106 and 114 may exchange a sequence of bursts and gaps as characterized in the SATA specifications.

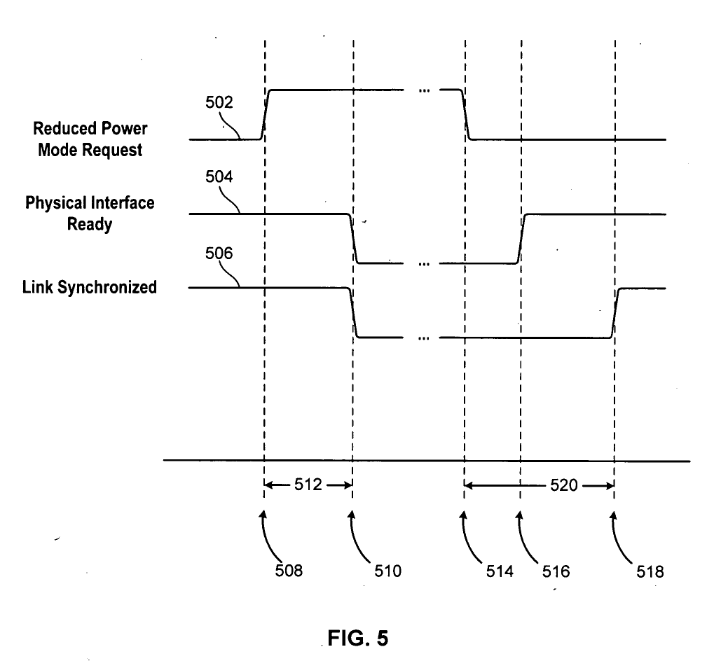

FIG. 5 is a timing diagram showing a relationship between a reduced power mode request, which is pictorially represented by the waveform 502, and the state of portions of the exemplary SATA system 200, which is pictorially represented by the waveforms Physical Interface Ready 504 and Link Synchronized 506. As shown, a reduced power mode is requested in the SATA system 200 at a time 508. The request could be made, for example, by the HDD 106 sending a PMREQ_P or PMREQ_S primitive to the host bus adapter. Subsequently, both SATA devices 106 and 114 may enter the reduced power mode. In the reduced power mode, the SATA devices may lose synchronization, and each SATA device 106 and 114 may shut down certain functional blocks to conserve power. When this happens, the SATA system 200 may be unavailable for data storage and retrieval, or the communication link between the devices may not be established. Referring back to FIG. 4, the SATA interface 124 may be in region 402. The transition from readiness to unavailability is pictorially represented by the transitions in Physical Interface Ready waveform 504 and Link Synchronized waveform 506 at a time 510. A period of time 512 bounded by time 508 and time 510 represents a transition time from the active power mode to a reduced power mode (hereafter, “sleep time”).

When one of the SATA devices 106 or 114 requests a return to the active power mode, which is pictorially represented by the transition of the Reduced Power Mode Request 502 at a time 514, each device may power up functional blocks that were shut down and may reestablish synchronization. A time 516 represents a time when the functional blocks are powered up. Between the time 516 and a time 518, synchronization may be reestablished by the SATA devices 106 and 114 exchanging sequences of bursts and gaps. As the SATA device 106 and 114 are reestablishing synchronization, the SATA interface 124 may be in region 404 (see FIG. 4). A time period 520 bounded by the time 514 and the time 518 represents a transition time from a reduced power mode to the active power mode (hereafter, “wakeup time”).

As described above, the SATA specifications may characterize a maximum wakeup time for each reduced power mode. For example, a SATA interface should “wake up” from a partial reduced power mode within 10 gs of receiving a wake up command (pictorially represented by the transition in the Reduced Power Mode Request waveform 502 at the time 514), and from a slumber reduced power mode within 10 ms of receiving a wakeup command. Actual wakeup times can vary greatly for different interfaces. For example, one host bus adapter-storage device combination may have a wake-up time 520 of 8 ms. Another host bus adapter-storage device combination may have a wake-up time 520 of less than 500 μs.

By dynamically determining the actual wakeup time of a particular SATA interface, a system may be able to adjust a power conservation strategy to conserve more power. For example, based on a 10 ms wakeup time from the slumber reduced power mode, a system may rarely enter the slumber reduced power mode. However, based on a wakeup time of 500 μs from the slumber reduced power mode, the system may enter the slumber reduced power mode more frequently and may stay in the slumber reduced power mode longer. Similarly, a SATA interface may enter the partial reduced power mode more frequently and stay in that mode longer.

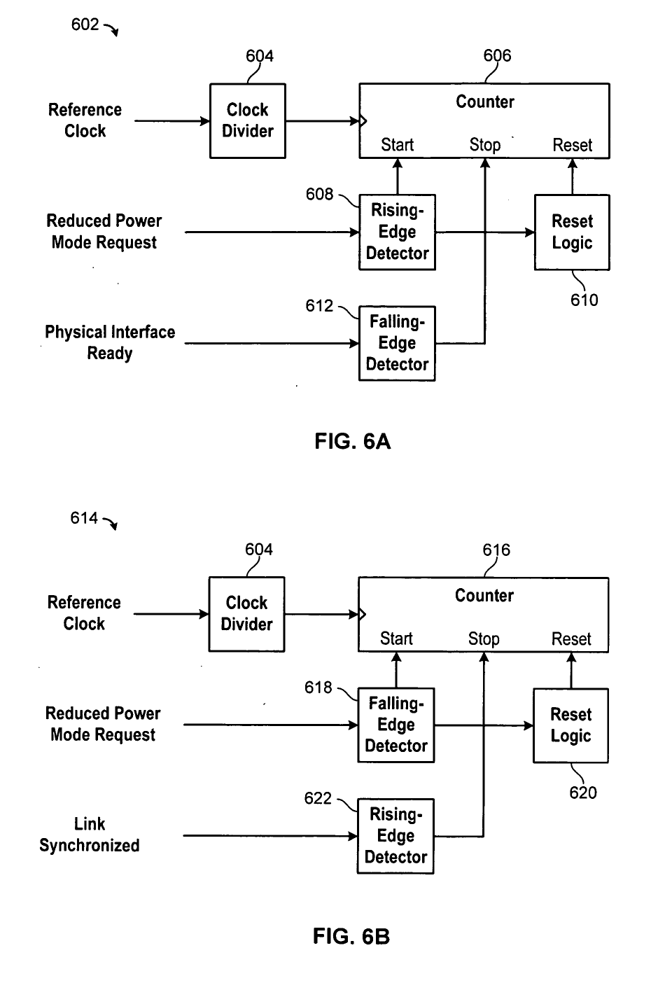

To dynamically determine the wakeup time of a particular SATA system 200, the SATA devices 106 and 114 may include one or more timers, such as timers 205 or 223. FIG. 6A and FIG. 6B show additional details of an exemplary embodiment of the timers 205 and 223.

The timer 205 and 223 may each comprise an exemplary timer circuit 602 to measure sleep time 512 and an exemplary timer circuit 614 to measure wakeup time 520. In the timer circuit 602, a clock divider 604 creates a reference clock signal from a clock signal in the SATA device. The reference clock signal is input to a counter 606. Functionally, a rising-edge detector 608 detects the transition in the waveform Reduced Power Mode Request signal 502 at the time 508 (see FIG. 5). In hardware or software, the rising-edge detector 608 may physically detect the assertion of PMREQ_P or PMREQ_S. Reset logic 610 is configured to reset the counter when appropriate. For example, the reset logic 610 may reset the counter 606 at the beginning of a timing period. The reset logic 610 may also reset the counter if part of the SATA interface is unable to enter a reduced power mode when a reduced power mode is requested. Functionally, a falling-edge detector 612 detects when the SATA interface has transitioned to a reduced power mode. Entry into a reduced power mode is pictorially represented by the transition of the waveform Physical Interface Ready 504 at the time 510. In hardware, a reduced power mode may be physically detected, for example, by system hardware sensing that the SATA interface lines are at a common mode voltage level. In software, a reduced power mode may be detected, for example, by the system querying a bit in a register.

To measure wakeup time 520, the timer circuit 614 also comprises a counter 616 and a reference clock signal. The reference clock signal may be generated by dividing, with the clock divider 604, a clock signal. Functionally, a falling-edge detector 618 detects the transition of the waveform Reduced Power Mode Request signal 502 at the time 514 (see FIG. 5). In hardware or software, the falling-edge detector 618 may physically detect, for example, an out-of-band signaling command that represents a request to transition from a reduced power mode to the active power mode. Reset logic 620 may be configured to reset the counter when appropriate. For example, the reset logic 620 may reset the counter 616 at the beginning of a timing period. The reset logic 620 may also reset the counter if part of the SATA interface is initially unable to enter a reduced power mode when a reduced power mode is requested. Functionally, a rising-edge detector 622 detects when the SATA interface has established a high-speed communication channel. Establishment of a high-speed communication channel is illustrated by the transition of the waveform Links Synchronized 506 at the time 518. In hardware, a high-speed communication channel may be physically detected, for example, by hardware sensing that the SATA interface lines are exchanging SYNC primitives and are not periodically at a common mode voltage level. In software, presence of a high-speed communication channel may be detected, for example, by the system querying a bit in a register.

Other embodiments of the timers 205 and 223 are possible. As described above, the timers 205 and 223 could comprise hardware, software, firmware, or any combination of hardware, software and firmware. The timers 205 and 223 could include a storage element (not shown) for storing a plurality of measurements, such as counter values from the counters 606 and 616. The timers 205 and 223 could aggregate separate sleep time 512 and wakeup time 520 values to determine a total “recovery” time for the SATA system 200. The timers 205 and 223 could further calculate an average value for a plurality of measurements stored in a storage element. A power management controller (not shown) could use the calculated average value to determine a time to transition between power modes.

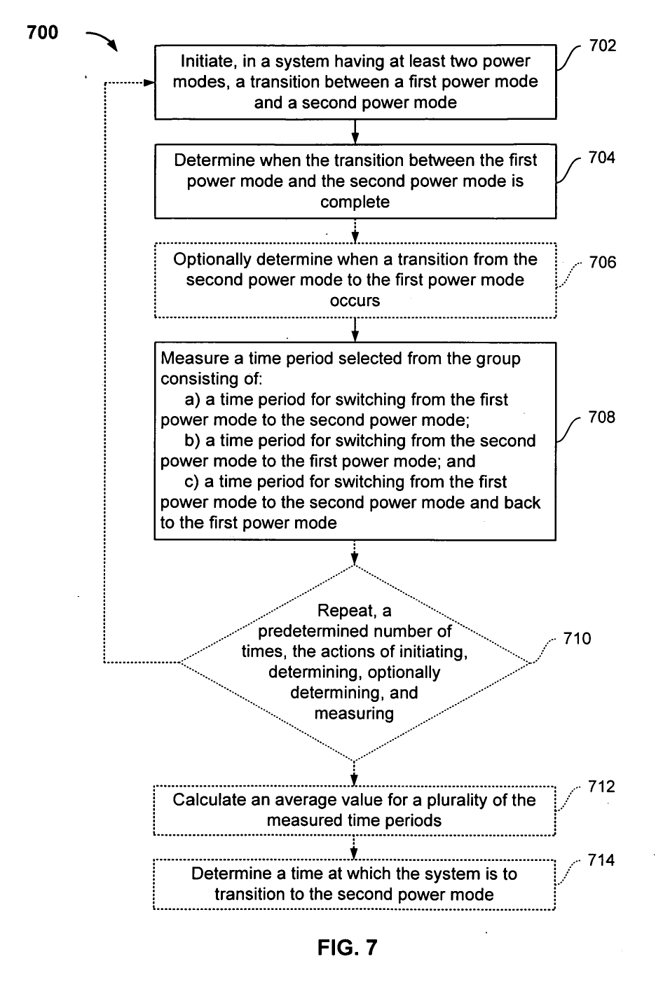

FIG. 7 is a flow diagram of a method 700 for determining a transition time between a first power mode and a second power mode. The method 700 may be performed in hardware, or software, or firmware, or in any combination of hardware, software, and firmware. For example, in the exemplary SATA system 200, the method 700 could be performed by firmware running in the interface and control block 218. As another example, the method 700 could be performed by software running in the microprocessor 108 and firmware running in the interface and control block 202. The method 700 includes the actions described below.

The method 700 includes, in an action 702, initiating in a system having at least two power modes, a transition between a first power mode and a second power mode. For example, the interface and control block 218 may initiate a transition from an active power mode to a partial reduced power mode. The interface and control block 218 could do this by, for example, causing a PMREQ_P primitive to be sent to the host bus adapter 114.

The method 700 further includes determining, in an action 704, when the transition between the first power mode and the second power mode is complete. For example, if the host bus adapter 114 is able to enter a partial reduced power mode upon receipt of the PMREQ_P primitive, it may issue a PMACK primitive. Subsequent to receiving a PMACK primitive, the interface and control block 218 may monitor the lines 217A and 217B to determine when voltage on them reaches a common mode voltage level.

The method 700 optionally includes determining, in an action 706, when a transition from the second power mode to the first power mode occurs. For example, after the interface and control block 218 determines that the transition from an active power mode to a partial reduced power mode has occurred, the interface and control block 218 may initiate a transition from the partial reduced power mode to the active power mode. The interface and control block 218 may then determine when the interface returns to the active power mode. For example, the interface and control block 218 code could send SYNC primitives via the physical interface block 211 and determine when SYNC primitives are received back from the host bus adapter 114.

The method 700 further includes measuring, in an action 708, a time period selected from the group consisting of: a) a time period for switching from the first power mode to the second power mode; b) a time period for switching from the second power mode to the first power mode; and c) a time period for switching from the first power mode to the second power mode and back to the first power mode. For example, the interface and control block 218 could use the timer 223 to measure time between initiation of the transition from an active power mode to the partial reduced power mode (sleep time 512). To make this measurement, the interface and control block 218 and the timer 223 may utilize the exemplary circuit 602. The interface and control block 218 and the timer 223 may also measure time between an initiation of a transition from the partial reduced power mode to the active power mode (wakeup time 520). To make this measurement, the interface and control block 218 and the timer 223 may utilize the exemplary timer circuit 614. By measuring both sleep time 512 and wake time 520, the interface and control block 218 could determine a time for switching from the first power mode to the second power and back to the first power mode.

The method 700 may include, in an optional series of actions pictorially represented by the decision block 710, repeating the actions of initiating (702), determining (704), optionally determining (706) and measuring (708). For example, the interface and control block 218 may repeat the above actions ten times, measuring (708) each respective time period. The method 700 may further include calculating an average value, in an action 712, for a plurality of the measured (708) time periods. Where the second power mode is selected from a plurality of reduced power modes, the actions of initiating (702), determining (704), optionally determining (706) and measuring (708) may be repeated for each reduced power mode. Moreover, the actions may be repeated a predetermined number of times for each reduced power mode, in order to make a plurality of measurements for each reduced power mode. Average values of two or more of the measurements corresponding to each reduced power mode may then be calculated.

The method 700 may further include, in an optional action 714, determining a time at which the system is to transition to the second power mode. If the second power mode is selected from a plurality of reduced power modes, the method 700 may include separately determining (714) a time at which the system is to transition to each reduced power mode. The time at which the system is to transition to each reduced power mode may be a function of the measured (708) time period for each reduced power mode or of an average value of two or more of the measured (708) time periods for each reduced power mode. The time at which the system is to transition to each reduced power mode may further be a function of a length of time during which at least part of the system is in an idle state.

The SATA system 200 may include a power management controller (not shown) that performs the method 700 to dynamically determine actual transition times between power modes, and based on the actual transition times, to determine times to transition to different reduced power modes. More specifically, by performing the actions of initiating (702), determining (704), optionally determining (706) and measuring (708), the power management controller may determine (714) that the SATA system 200 should transition to the partial reduced power mode after, as an example 5 μs, and transition to the slumber reduced power mode after, as an example, 500 μs. If the SATA system 200 initiates an operation, such as a HDD read operation that will take 6 ms, the power management controller may request a transition to the slumber reduced power mode. If the SATA system had not performed the method 700, it may have only requested transitions to the slumber reduced power mode upon executing operations that take 10 ms or longer. In this manner, implementation of method 700 may result in the SATA system 200 requesting a slumber reduced power mode more frequently than it would have if actual transition times had not been determined. As another example, if the SATA system 200 initiates an operation that will take 7 μs, the power management controller may request a transition to the partial reduced power mode. If the SATA system had not performed the method 700, it may have only requested transitions to the partial reduced power mode upon executing operations that take 10 μs or longer. As yet another example, if the power management controller had previously requested a transition to the partial reduced power mode, and the SATA system had transitioned to the reduced power and remained there for over 500 μs, the power management controller may initiate a transition back to the first power mode and then initiate another transition to the slumber reduced power mode.

Embodiments may be implemented, at least in part, in hardware or software or in any combination thereof. Hardware may include, for example, analog, digital or mixed-signal circuitry, including discrete components, integrated circuits (ICs), or application-specific ICs (ASICs). Embodiments may also be implemented, in whole or in part, in software or firmware, which may cooperate with hardware. Processors for executing instructions may retrieve instructions from a data storage medium, such as EPROM, EEPROM, NVRAM, ROM, RAM, a CD-ROM, a HDD, and the like. Computer program products may include storage media that contain program instructions for implementing embodiments described herein.

A number of embodiments have been described. Nevertheless, it will be understood that various modifications may be made without departing from the spirit and scope of this disclosure. For example, embodiments may be applied to communication interfaces other than SATA interfaces, and to communication interfaces that will be developed in the future. Accordingly, other embodiments are within the scope of the following claims.

What is claimed is:

1. A power management method comprising:
(a) initiating, in a system having at least two power modes, a transition between a first power mode and a second power mode;
(b) determining when the transition between the first power mode and the second power mode is complete;
(c) optionally determining when a transition from the second power mode to the first power mode occurs; and
(d) measuring a time period selected from the group consisting of:
a time period for switching from the first power mode to the second power mode;
a time period for switching from the second power mode to the first power mode; and
a time period for switching from the first power mode to the second power mode and back to the first power mode.

2. The power management method of claim 1, further comprising repeating the actions (a), (b), (c) and (d) a predetermined number of times.

3. The power management method of claim 2, further comprising calculating an average value for a plurality of the measured time periods.

4. The power management method of claim 1, wherein the system draws more power in the first power mode than in the second power mode.

5. The power management method of claim 4, further comprising determining a first time at which the system is to transition to the second power mode, wherein the first time is a function of the measured time period and of a length of time during which at least part of the system is in an idle state.

6. The power management method of claim 4, wherein the second power mode is selected from a plurality of reduced power modes, the system having a different level of power consumption in each reduced power mode that is less than a level of power consumption in the first power mode, the power management method further comprising performing the actions (a), (b), (c) and (d) for each reduced power mode.

7. The power management method of claim 6, further comprising determining a plurality of times at which the system is to transition to a reduced power mode that is selected from the plurality of reduced power modes, wherein each time in the plurality of times corresponds to a transition from the first power mode to a different reduced power mode in the plurality of reduced power modes and wherein each time is a function of a measured time period corresponding to the transition between the first power mode and the different reduced power mode and further a function of a length of time during which at least part of the system is in an idle state.

8. The power management method of claim 7, further comprising initiating in the system a transition from the first power mode to a reduced power mode that is selected from the plurality of reduced power modes, at a determined time that is selected from the plurality of determined times.

9. The power management method of claim 1, wherein determining whether the transition between the first power mode and the second power mode is complete comprises monitoring a signal in the system to determine when the signal has a value associated with the second power mode.

10. The power management method of claim 1, wherein the system comprises a data storage device, a processor, and a serial communication interface connecting the data storage device and the processor.

11. The power management method of claim 10, wherein the data storage device is a hard disc drive.

12. The power management method of claim 1, wherein the action of initiating the transition between the first power mode and the second power mode is performed in response to a processor executing instructions.

13. The power management method of claim 1, wherein a digital timer circuit is used to perform the action of measuring the time period.

14. A data processing system having at least a first power mode and a second power mode, the data processing system comprising:
a data storage device that stores and retrieves data;
a processor that transmits data to be stored in the data storage device and that receives data that has been retrieved from the data storage device;
an interface that couples the data storage device and the processor; and
a power management controller that:
(a) initiates, in the data processing system, a transition between the first power mode and the second power mode;
(b) determines when the transition between the first power mode and the second power mode is complete;
(c) optionally determines when a transition from the second power mode to the first power mode occurs; and
(d) measures a time period selected from the group consisting of:
a time period for switching from the first power mode to the second power mode;
a time period for switching from the second power mode to the first power mode; and
a time period for switching from the first power mode to the second power mode and back to the first power mode.

15. The data processing system of claim 14, wherein the power management controller repeats the actions (a), (b), (c) and (d) a predetermined number of times.

16. The data processing system of claim 15, wherein the power management controller further calculates an average value for a plurality of the measured time periods.

17. The data processing system of claim 14, wherein the data processing system draws more power in the first power mode than in the second power mode.

18. The data processing system of claim 17, wherein the power management controller further determines a first time at which the data processing system is to transition to the second power mode, wherein the first time is a function of the measured time period and of a length of time during which at least part of the data processing system is in an idle state.

19. The data processing system of claim 17, wherein the second power mode is selected from a plurality of reduced power modes, the data processing system having a different level of power consumption in each reduced power mode that is less than a level of power consumption in the first power mode, wherein the power management controller further performs the actions (a), (b), (c) and (d) for each reduced power mode.

20. The data processing system of claim 19, wherein the power management controller further determines a plurality of times at which the data processing system is to transition to a reduced power mode that is selected from the plurality of reduced power modes, wherein each time in the plurality of times corresponds to a transition from the first power mode to a different reduced power mode in the plurality of reduced power modes and wherein each time is a function of a measured time period corresponding to the transition between the first power mode and the different reduced power mode and further a function of a length of time during which at least part of the data processing system is in an idle state.

21. The data processing system of claim 14, wherein determining whether the transition between the first power mode and the second power mode is complete comprises monitoring a signal in the data processing system to determine when the signal has a value associated with the second power mode.

22. The data processing system of claim 14, wherein the data storage device is a hard disc drive.

23. The data processing system of claim 14, wherein the data storage device comprises a data storage device controller, the data storage device controller comprising the power management controller.

24. The data processing system of claim 14, wherein the processor comprises a data storage interface controller, the data storage interface controller comprising the power management controller.

25. In a data processing system that has at least a first power mode and a second power mode, wherein the data processing system comprises a data storage device that stores and retrieves data, a processor that transmits data to be stored in the data storage device and that receives data that has been retrieved from the data storage device, and an interface that couples the data storage device and the processor, a power management controller that:
(a) initiates, in the data processing system, a transition between the first power mode and the second power mode;
(b) determines when the transition between the first power mode and the second power mode is complete;
(c) optionally determines when a transition from the second power mode to the first power mode occurs; and
(d) measures a time period selected from the group consisting of:
a time period for switching from the first power mode to the second power mode;
a time period for switching from the second power mode to the first power mode; and
a time period for switching from the first power mode to the second power mode and back to the first power mode.
